(19) United States
(12) Patent Application Publication
(10) Pub. No.: US 2024/0200603 A1
(43) Pub. Date: Jun. 20, 2024

(54) THRUST BEARING FOR SUSPENSION SYSTEMS

(71) Applicant: Schaeffler Technologies AG & Co. KG, Herzogenaurach (DE)

(72) Inventors: Donggyun Choo, Busan-si (KR); Jongdae Roh, Busan-si (KR); Sunkyu Kwon, Changwon-si, Gyeongsangnam-do (KR); Dongha Lee, Seoul (KR)

(73) Assignee: Schaeffler Technologies AG & Co. KG, Herzogenaurach (DE)

(21) Appl. No.: 18/287,213

(22) PCT Filed: Apr. 12, 2022
(86) PCT No.: PCT/DE2022/100277

§ 371 Date: Oct. 17, 2023

(30) Foreign Application Priority Data
Apr. 23, 2021 (KR) 10-2021-0052802

(51) Int. Cl. F16C 33/76; F16C 33/78

(52) U.S. Cl. CPC F16C 33/761; F16C 33/782; F16C 2326/05

(57) ABSTRACT

A thrust bearing for suspension systems includes an upper element, a lower element, a bearing disposed between the upper element and the lower element, a primary sealing part and a secondary sealing part. The upper element includes a circumferentially formed contact surface with a joining point. The primary sealing part contacts the upper element and the lower element in an outer opening formed on a radial outside of the bearing. The primary sealing part has a joining surface joined to the contact surface and an area increase element joined to the joining point. The secondary sealing part contacts the upper element and the lower element in an inner opening formed on a radial inside of the bearing.

### CROSS-REFERENCE TO RELATED APPLICATIONS

This application is the United States National Phase of PCT Appln. No. PCT/DE2022/100277 filed Apr. 12, 2022, which claims priority to Korean Application No. KR10-2021-0052802 filed Apr. 23, 2021, the entire disclosures of which are incorporated by reference herein.

### TECHNICAL FIELD

The present disclosure relates to the field of thrust bearings for suspension systems. More particularly, the invention relates to a thrust bearing for suspension systems which limits radial and circumferential separation and prevents separation by increasing the contact area of the upper element and sealing points.

### BACKGROUND

Suspension systems in motor vehicles are components that cushion the forces generated during driving from the road surface, preventing them from being transmitted directly to the chassis and improving driving comfort. Depending on how these systems are attached to the chassis and how they absorb the shock, they can be used in different ways. Thrust bearings are the most commonly used on regular cars.

The bearings are provided in the shock absorbers because the suspension systems must be attached to the chassis so that the shock absorbers can rotate according to the driver's steering movements.

One side of the shock absorber is firmly joined to the chassis, while the other side is connected to the wheel via steering knuckles and rotates with the steering knuckle when steering. The shock absorbers that absorb the shock from the road are also included and the push rod brackets are designed to be attached to the chassis. The upper part of the shock absorber's bumper is attached to the chassis via an insulator. A bearing module is attached to the underside of the isolator and is supported by connection to a spring. The transmitted shock is dampened by this structure as the shock absorber and spring translate and rotate along the axis.

The assembled state of the thrust bearing is described with reference to FIG. 2 of the South Korean Official Gazette Unex. Pub. No. 10-2014-0120452

As shown in FIG. 1, the thrust bearing (1) includes an upper element (10), a lower element (20) arranged below the upper element (10) and a bearing (30) located between the upper element (10) and the lower element (20).

The bearing (30) includes an annular primary raceway (31) held in contact with the upper element (10), an annular secondary raceway (33) held in contact with the lower element (20), and multiple rolling elements (35) which are arranged in the circumferential direction between the primary raceway (31) and the secondary raceway (33).

A primary sealing part (51) and a secondary sealing part (53) are provided at the opening inside and outside in the radial direction of the bearing (30). The primary sealing part (51) is between the upper element (10) and the lower element (20) on the radially outer side of the bearing (30). The secondary sealing part (53) is between the upper element (10) and the lower element (20) on the radially inner side of the bearing (30).

As shown in FIG. 2, the upper connection point (511) of the primary sealing part (51) is connected to the upper element (10), and the sealing lip (513) of the lower part is placed in contact with the lower part (20). The secondary sealing part (53) has its upper element inserted into the upper element (10). The primary sealing part (51) and the secondary sealing part (53) consist of thermoplastic elastomers—for example TPU (thermoplastic polyurethane).

The upper element (10) and the lower element (20) are ring-shaped. The upper element (10) and lower element (20) are made of an engineering plastic with high rigidity. Possible materials for the upper element (10) and lower element (20) include nylon 6, nylon 66, nylon 6 with fiberglass, or nylon 66 with fiberglass.

A metallic reinforcement material (21) is also provided in the lower part (20). A spring pad (40) is located on the underside of the lower element (20). The spring pad (40) is in contact with the upper part of the spring. The spring pad (40) includes thermoplastic elastomers, for example TPU (thermoplastic polyurethane).

As shown in FIG. 2, the upper joining point (511) of the primary sealing part (51) is inserted into the upper element (10), and the upper element and the joining surface (515), which is the outer surface in the radial direction, are joined to the upper element (10).

Conventional thrust bearings for suspension systems (1) had the problem that the primary sealing part (51) and the secondary sealing part (53) were separated from the upper element (10) due to the continuous fatigue load in driving. The primary sealing part (51) on the radially outer side was particularly susceptible to separation of the primary sealing part (51) and the upper element (10) because it was at a point more exposed to moisture and dust.

Other prior art documents include Republic of Korea, Disclosure No. 10-2001-0107829, Patent Application and Republic of Korea, Disclosure No. 10-2014-0120452, Patent Application.

### SUMMARY

to the present disclosure provides a thrust bearing design for suspension systems that prevents the separation of the upper part and the primary sealing part and/or the secondary sealing part. In an example embodiment, the separation is prevented by increasing the contact area between the upper element and the primary sealing part.

The present disclosure provides a thrust bearing for suspension systems, consisting of an upper element, a lower element which is provided below the upper element, a bearing which is provided between the upper element and the lower element, and a primary and secondary sealing part which are joined to the upper element at the opening that is formed radially on both sides of the upper and lower element. The thrust bearing has one or more elements of increasing surface area, which enlarge the area of contact with the upper part and which, in a circumferential direction, are formed in one or more of the primary or secondary sealing parts on the surface by which said sealing parts are joined to the upper part. The thrust bearing also has a joining point of the upper element, which is joined to the sealing part of the upper element.

In the thrust bearing for suspension systems, the element with a circumferential increase in surface area is formed in the form of a concave recess with some intervals between each part on the joining surface of the primary sealing part. The joining point of the upper part is provided as a convex element with increase in surface area, which is joined to the concave element with an increase in surface area on the joining surface of the upper element.

In the thrust bearing for suspension systems, the element with increase in surface area is formed with an outward and upward opening, including the radially outward base, a side provided on both circumferential sides of the base surface, and the bottom surface provided in the bottom of the base surface. The joining point of the upper part is a convex area-increasing point joined to the base surface, the side and the bottom surface.

In the above-mentioned thrust bearing for suspension systems, the side surface and the base surface are at an acute angle to one another.

The disclosed thrust bearing restricts the separation in the radial direction and in the circumferential direction and prevents the separation by increasing the contact area of the upper element and the sealing part.

### BRIEF DESCRIPTION OF THE DRAWINGS

The present disclosure is explained below with reference to the attached figures, in which:

FIG. 1 is a half-sectional perspective view of the conventional thrust bearing for suspension systems,

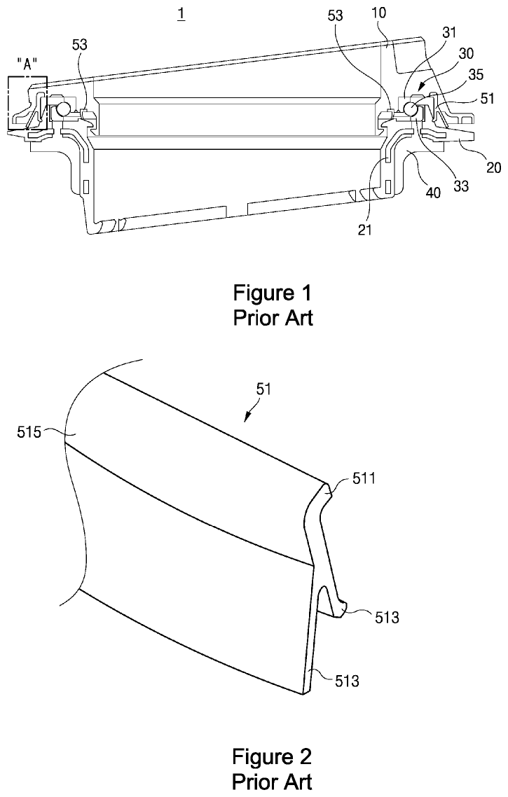

FIG. 2 is an enlarged view of part “A” of FIG. 1 and a sectional view of the primary sealing point,

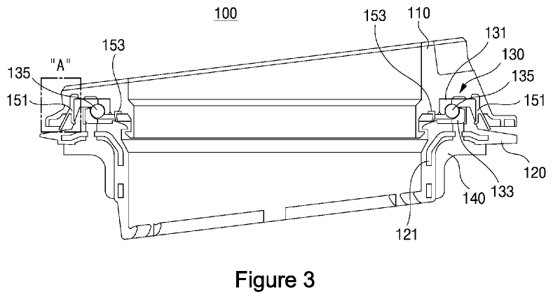

FIG. 3 is a sectional view of an example embodiment of a thrust bearing assembly for suspension systems,

FIG. 4 is an enlarged view of part “A” of FIG. 3 and is an enlarged sectional view to clarify the joining between the primary sealing part and the upper element, and

FIGS. 5 and 6 are an enlarged view of part “A” of FIG. 3 and an enlarged sectional view showing the modified joining between the primary sealing part and the upper element.

### DETAILED DESCRIPTION

All technical and scientific terms used in this disclosure have the same meanings as understood by a person skilled in the technical field of this disclosure, unless otherwise defined. All terms used in this disclosure have been selected with the intention of providing further explanation of this disclosure and not in order to limit the legal scope of this disclosure.

It is to be understood that the terms used herein, including “comprising,” “provided,” and “having,” unless specified in the number or sentence containing the term, are to be construed as open-ended terms, which includes the possibility of other practical examples. It is understood that the terms used herein in the singular for explaining this disclosure can also have this meaning in the plural, unless otherwise specified. This fact also applies to the primary forms of claims.

It should be understood that the terms “primary” and “secondary” as used herein make a distinction between several components without limiting the order or importance of those components.

As used herein, the terms “joined to” and “attached to” mean that one component may be joined or attached to another component, directly or through a new component.

Referring to the figures, the thrust bearing for suspension systems will be explained in detail.

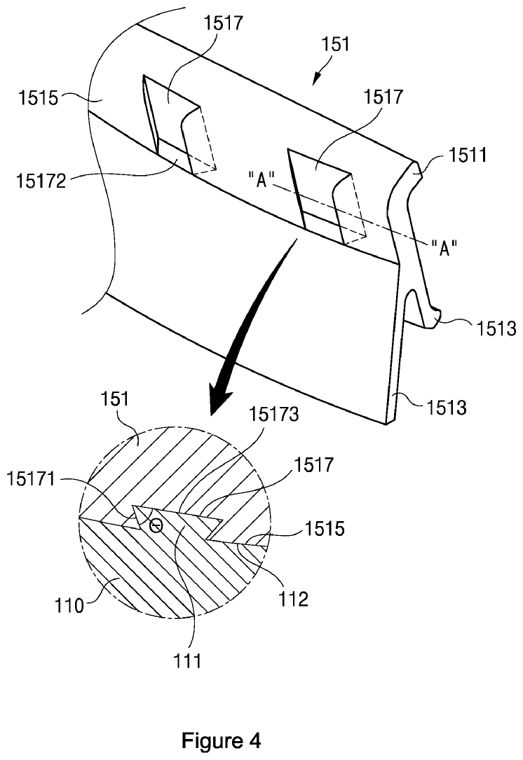

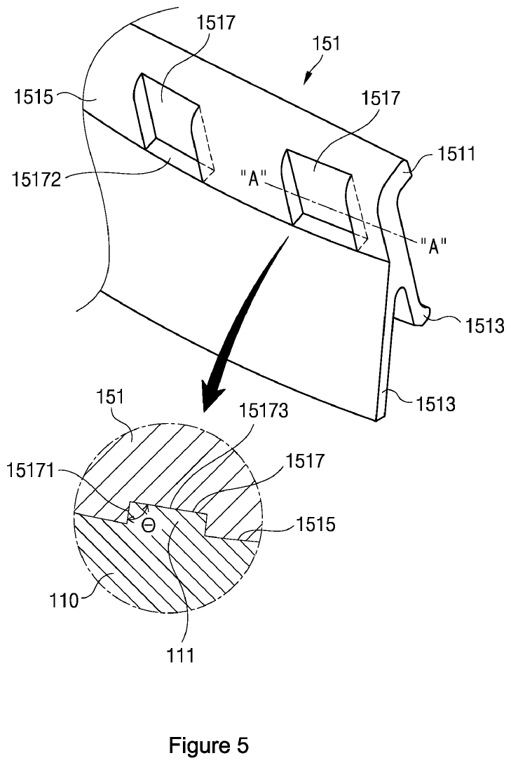

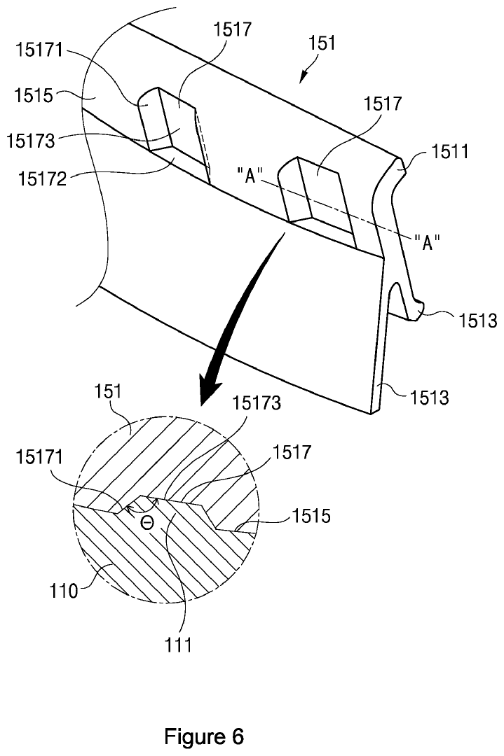

FIG. 3 is a half sectional view of an example embodiment of a thrust bearing assembly for suspension systems, FIG. 4 is an enlarged view of part “A” of FIG. 3 and is an enlarged sectional view provided to show the joining between the primary sealing point and the upper part, and FIGS. 5 and 6 are an enlarged view of part “A” of FIG. 3 and an enlarged sectional view showing the modified connection between the primary sealing part and the upper part.

For the explanations below, the horizontal direction of FIG. 3 is defined as the “radial direction” and the vertical direction of FIG. 3 is defined as the “vertical direction.” As shown in FIG. 3, the thrust bearing for suspension systems (100) includes an upper element (110), a lower element (120) provided below the upper element (110), a bearing (130) provided between the upper element (110) and the lower element (120), and the sealing part between the upper element (110) and the lower element (120) which is formed on the joining surface provided at the opening formed on both sides of the radial direction of the bearing (130).

The upper element (110) is ring-shaped. The upper element (110) is made of an engineering plastic with high rigidity. Materials for the upper element (110) include nylon 6, nylon 66, nylon 6 with fiberglass, or nylon 66 with fiberglass.

The lower element (120) is ring-shaped. The lower element (120) includes a cylindrical element and a flange element whose upper element is bent and extends outward in the radial direction. The lower element (120) is made from an engineering plastic with high rigidity. Materials for the lower element (120) include nylon 6, nylon 66, nylon 6 with fiberglass, or nylon 66 with fiberglass.

The lower element (120) can additionally contain reinforcing material (121). The reinforcing material (121) is ring-shaped and includes metal sheets. The reinforcing material (121) is cylindrical, and the upper element is curved and extends radially outwards.

The reinforcing material (121) is introduced when the lower element (120) is formed and is located within the formed lower element (120). The lower element (120) is injection molded using the reinforcing material (121) as an insert.

The lower element (120) additionally contains a spring pad (140).

The spring pad (140) is ring-shaped and is supplied as the lower part of the lower element (120). The spring pad (140) is located on the radially outer side of the cylindrical portion of the lower element (120) as the lower element of the flange element. The upper part of a suspension spring is provided in contact with the lower part of the spring pad (140). The spring pad (140) includes thermoplastic elastomers. Thermoplastic elastomers comprise TPU (thermoplastic polyurethane). The spring pad (140) has a lower hardness compared to the lower element (120) because it is made of thermoplastic elastomers that can absorb the shock transmitted by the suspension system.

The spring pad (140) is injection molded with the lower element (120) in which the reinforcing material (121) is inserted.

The bearing (130) includes an annular primary raceway (131) held in contact with the upper element (110), an annular secondary raceway (133) held in contact with the lower element (120), and multiple rolling elements (135) which are lined up in the circumferential direction between the primary raceway (131) and the secondary raceway (133).

The sealing part is provided at the opening formed radially on both sides between the upper element (110) and the lower element (120). The sealing part is firmly connected to the upper element (110). The sealing part includes thermoplastic elastomers. Thermoplastic elastomers comprise TPU (thermoplastic polyurethane).

The sealing part includes a ring-shaped primary sealing part (151) provided at an opening formed in the radial direction outside of the bearing (130) and an annular secondary sealing part (153) provided at the opening formed in the radial direction inside the bearing (130).

The sealing part is injection molded with the upper element (110) used by means of an insert during molding. The sealing parts are injection molded with the upper element (110) inserted, and a surface area-increasing element is formed at least on one of the primary sealing part (151) and the secondary sealing part (153).

An example in which the surface area-increasing element (1517) is formed at the primary sealing part (151) and is joined to the upper element (110) will be explained below with reference to FIG. 4.

Said primary sealing part (151) is ring-shaped. A joining point (1511) where an upper element is bent radially inward and a sealing lip (1513) branches therefrom and extends to the bottom is provided in said primary sealing part (151). The short part of the sealing lip (1513) is in contact with the upper surface of the lower element (120).

An element with surface area increase (1517) that increases the contact area with the upper element (110) is formed on the joining surface (1515) with the upper element (110) outward in the radial direction of the primary sealing part (151). One or more of the surface area-increasing parts (1517) are formed circumferentially along the joining surface (1515). The element with an increase in surface area (1517) is formed in the shape of a concave recess.

The element with an increase in surface area (1517) is formed with an outward-upward opening which comprises the radially outward-facing base surface (15173), a side (15171) provided on both circumferential sides of the base surface (15173) and the bottom surface (15172) provided on the underside of the base surface (15173).

The joining point (111) of the upper part, a convex area-increasing element which connects to the area-increasing element (1517), is additionally provided on the joining surface (112) of the upper element (110) in contact with the contact surface (1515) of the primary sealing part. The joining point (111) of the upper element is formed protruding radially inward on the inside of the circumferential direction on the upper element (110) where the primary sealing part (151) is joined. The joining point (111) of the upper part is formed on the joining surface (112) of the upper part protruding radially inward. Multiple joining points (111) of the upper element are formed with certain intervals between each point along the circumferential direction.

The primary sealing part (151) is injected using the upper element (110) as an insert and is joined to the upper element (110). The primary sealing part (151) is injection molded from the upper element (110), and the joining point of the top part is provided as an insert. The surface area increase element (1517) is formed at the point where the joining point of the upper part is provided and the element with the surface area increase (1517) joins to the joining point (111) of the upper part.

The joining point of the upper part (111) protrudes towards the element with an increase in surface area (1517) and is joined to the base surface (15173), the side surface (15171) and the bottom surface (15172). A side surface (15171) is formed on both sides of the circumferential direction, and since the joining point (111) of the upper part is joined to the base surface (15173) and the two side surfaces (15171), the relative circumferential movement of the upper element (110) and of the primary sealing part (151) is prevented, thereby suppressing the separation of the upper element (110) and the primary sealing part (151).

The side surface (15171) and the base surface (15173) of the surface area-increasing V are at an acute angle. Since the side surface (15171) and the base surface (15173) are at an acute angle and the connection point (111) of the upper part is connected to the base surface (15173) and the two side surfaces (15171), the relative radial movement of the upper element (110) and the primary sealing part (151) is prevented, thereby suppressing the radial separation of the upper element (110) and the primary sealing part (151).

As shown in FIG. 5 and FIG. 6, the side surface (15171) and the base surface (15173) of the element with increase in surface area (1517) may be arranged at a right angle or at an obtuse angle.

The sealing lip (1513) should branch off from the underside of the joining surface, which is the lower part of the upper element (110). When the branch of the scaling lip (1513) is above the lower element of the upper element (110), the separation of the upper element (110) and the contact surface (1515) can be facilitated because the scaling lip (1513) deforms when an external force is applied.

1. A thrust bearing for suspension systems, comprising:
an upper element;
a lower element on the underside of the upper element;
a bearing between the upper element and the lower element;
a primary and a secondary sealing part communicating with the upper element in an opening formed radially on either side between the upper element and the lower element;
wherein an area increase element increases a joining surface area to the upper element on a circumferentially formed contact surface with the sealing parts to the upper element on one or more sealing parts, a connection point for the upper element being formed by the area increase element with the upper element.

2. The thrust bearing for suspension systems according to claim 1, wherein the element with circumferential increase in surface area is formed in the form of a concave depression with intervals between the individual parts on the joining surface of the primary sealing point, and the joining point for the upper element protrudes towards the increase in area element and connects thereto at the joining surface of the upper element.

3. The thrust bearing for suspension systems according to claim 2, wherein said element with increase in surface area is formed with an outwardly and upwardly facing opening which receives the radially outwardly facing base surface, a side of the circumferential sides of a base surface and a bottom surface at a bottom of the base surface, wherein the connection point projects to a region of increasing convex shape, and is joined to the base surface, the side and the bottom surface.

4. The thrust bearing for suspension systems according to claim 3, wherein the side surface and the base surface form an acute angle.

5. A thrust bearing for suspension systems, comprising:
an upper element comprising a circumferentially formed contact surface having a joining point;
a lower element;
a bearing disposed between the upper element and the lower element;
a primary sealing part contacting the upper element and the lower element in an outer opening formed on a radial outside of the bearing, the primary sealing part comprising a joining surface joined to the contact surface and an area increase element joined to the joining point;
a secondary sealing part contacting the upper element and the lower element in an inner opening formed on a radial inside of the bearing.

6. The thrust bearing of claim 5, wherein the area increase element is a concave depression and the joining point protrudes towards the area increase element from the contact surface.

7. The thrust bearing of claim 6, wherein the area increase element comprises:
a base surface; and
an outwardly and upwardly facing opening extending from the base surface in a region o9f increasing convex shape, the opening being formed by a pair of circumferential side surfaces and a bottom surface, wherein the joining point:
projects to the region of increasing convex shape; and
is joined to the base surface, the pair of circumferential side surfaces and the bottom surface.

8. The thrust bearing of claim 7, wherein each of the pair of circumferential side surfaces forms an acute angle with the base surface.
